(19) United States
(12) Patent Application Publication
(10) Pub. No.: US 2026/0003583 A1
(43) Pub. Date: Jan. 1, 2026

(54) INTERFACE PROCESSING

(71) Applicant: Beijing Zitiao Network Technology Co., Ltd., Beijing (CN)

(72) Inventor: Longteng PENG, Beijing (CN)

(21) Appl. No.: 18/984,234

(22) Filed: Dec. 17, 2024

(30) Foreign Application Priority Data
Jun. 30, 2024 (CN) 202410870566.3

(51) Int. Cl. G06F 8/35; G06F 8/10; G06F 11/3668

(52) U.S. Cl. CPC G06F 8/35; G06F 8/10; G06F 11/3688; G06F 11/3692

(57) ABSTRACT

A method, a device, and a storage medium for interface processing are provided. In the method, in response to a request to create an interface, an interface definition for the interface is obtained, a first definition content in the interface definition and a prompt are provided to a machine learning model, to obtain a second definition content generated by the machine learning model for the interface. The interface definition for the interface is updated based on the second definition content, and the interface is created with the updated interface definition.

### CROSS-REFERENCE

This application claims the benefit of Chinese Patent Application No. 202410870566.3 filed on Jun. 30, 2024, entitled “METHOD, APPARATUS, DEVICE, STORAGE MEDIUM AND PROGRAM PRODUCT FOR INTERFACE PROCESSING”, which is hereby incorporated by reference in its entirety.

### FIELD

Example embodiments of the present disclosure generally relate to the field of computers, and more particularly, to interface processing.

### BACKGROUND

In the process of developing an application, developers generally need to define an interface (such as an application programming interface (API)) at a server, and provide a description file of the API definition to a client. The client may call the corresponding API based on the API definition. One or more functions of the corresponding application or service may be accessed via the API. In a scenario of conversing with a digital assistant, developers generally need to develop an API that may be understood by the digital assistant, such that the digital assistant may be triggered to call the API to execute the corresponding function during the conversation.

### SUMMARY

In a first aspect of the present disclosure, a method for interface processing is provided. In the method, in response to a request to create an interface, an interface definition for the interface is obtained, and a first definition content in the interface definition and a prompt are provided to a machine learning model, to obtain a second definition content generated by the machine learning model for the interface. In the method, the interface definition for the interface is updated based on the second definition content, and the interface is created with the updated interface definition.

In a second aspect of the present disclosure, an electronic device is provided. The electronic device includes at least one processing unit and at least one memory. The at least one memory is coupled to the at least one processing unit and stores instructions for execution by the at least one processing unit. The instructions, when executed by the at least one processing unit, cause the electronic device to perform the method of the first aspect.

In a third aspect of the present disclosure, there is provided a computer readable storage medium having a computer program stored thereon. The computer program is executable by a processor to perform the method of the first aspect.

In a fourth aspect of the present disclosure, there is provided a computer program product. The computer program product includes a computer program that, when executed by a processor, performs the method according to the first aspect of the present disclosure.

It should be understood that what is described in this section is not intended to limit the critical features or essential features of the embodiments of the present disclosure, nor is it intended to limit the scope of the present disclosure. Other features of the present disclosure will be readily appreciated from the following description.

### BRIEF DESCRIPTION OF THE DRAWINGS

These and other features, advantages, and aspects of various embodiments of the present disclosure will become more apparent from the following detailed description made with reference to the accompanying drawings. In the drawings, the same or similar reference numerals denote the same or similar elements, in which:

FIG. 1 illustrates a schematic diagram of an example environment;

FIG. 2A illustrates a flowchart of an example signaling flow for interface processing;

FIG. 2B illustrates a flowchart of an example signaling flow for interface processing;

FIG. 3 illustrates a diagram of an example of a classification architecture for interfaces;

FIG. 4 illustrates a schematic diagram of an example signaling flow for interface processing;

FIG. 5 illustrates a flowchart of an example process for interface processing;

FIG. 6 illustrates an example block diagram of an apparatus for interface processing; and

FIG. 7 illustrates a block diagram of an example electronic device capable of implementing various embodiments of the present disclosure.

### DETAILED DESCRIPTION

Embodiments of the present disclosure will be described in more detail below with reference to the accompanying drawings. Although certain embodiments of the present disclosure are illustrated in the accompanying drawings, it should be understood that, the present disclosure may be implemented in various forms and should not be construed as limited to the embodiments set forth herein. On the contrary, these embodiments are provided for a more thorough and complete understanding of the present disclosure. It should be understood that, the drawings and embodiments of the present disclosure are provided for illustrative purposes only and are not intended to limit the scope of protection of the present disclosure.

In the description of the embodiments of the present disclosure, the term “including” and the like should be understood as non-exclusive inclusion, that is, “including but not limited to”. The term “based on” should be read as “based at least in part on”. The term “one embodiment” or “the embodiment” should be read as “at least one embodiment”. The term “some embodiments” should be understood as “at least some embodiments”. Other explicit and implicit definitions may also be included below. The terms “first”, “second”, etc. may refer to different or identical objects. Other explicit and implicit definitions may also be included below.

Herein, unless explicitly stated, performing a step “in response to A” does not mean that the step is performed immediately after “A”, but may include one or more intermediate steps.

It will be appreciated that the data (including but not limited to the data itself, data acquisition, use, storage, or deletion) involved in the technical solutions of the present disclosure should comply with the requirements of the corresponding laws, regulations and relevant provisions.

It should be understood that, before the technical solutions of the embodiments of the present disclosure are used, the relevant users should be informed of the type, the usage scope, the usage scenario of the information in an appropriate manner according to relevant laws and regulations, and authorization of the relevant users should be obtained. The relevant users may include any type of entitlement bodies, such as individuals, enterprises, and groups.

For example, in response to receiving an unsolicited request from a user, prompt information is sent to the relevant user to explicitly remind the relevant user that the operation requested to be executed will need to obtain and use information of the relevant user, such that the relevant user may autonomously select, according to prompt information, whether to provide information for software or hardware (such as an electronic device, an application, a server, or a storage medium) that executes the operation of the technical solutions of the present disclosure.

As an optional but non-limiting implementation, in response to receiving an unsolicited request from the relevant user, for example, the prompt information may be sent to the relevant user by a pop-up window, and the prompt information may be presented in the form of text in the pop-up window. In addition, the popup window may also carry a selection control for the user to select “agree” or “don't agree” to provide information to the electronic device.

It should be understood that, the above notifying and obtaining the user authorization process are merely exemplary, and do not limit the implementation of the present disclosure, and other methods meeting relevant laws and regulations may also be applied to the implementation of the present disclosure.

As used herein, the term “model” refers to a program that provides an association between an input and an output learned from training data, and thus a corresponding output may be generated for a given input after training the model. The generation of the model may be based on a machine learning technique. Deep learning is a machine learning algorithm that processes inputs and provides corresponding output with a multi-tiered processing unit. A neural network model is an example of a model based on deep learning. As used herein, “model” may also be referred to as “machine learning model”, “learning model”, “machine learning network”, or “learning network,” which are used interchangeably herein.

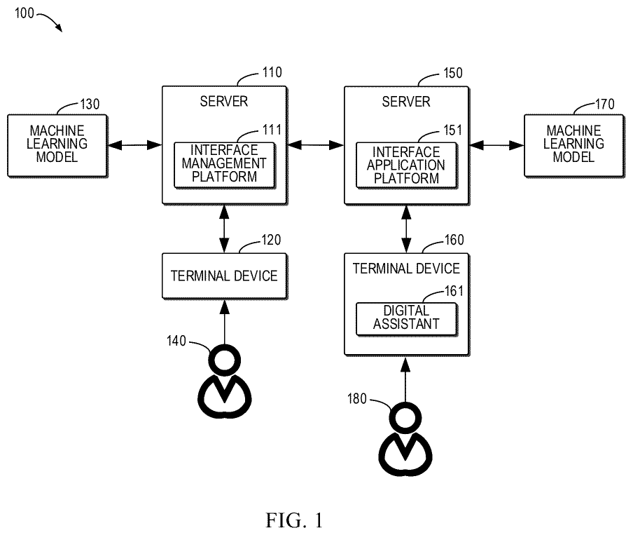

FIG. 1 illustrates a schematic diagram of an example environment 100 in which embodiments of the present disclosure may be implemented. The environment 100 involves an interface management platform 111, an interface application platform 151, servers 110 and 150, terminal devices 120 and 160, and machine learning models 130 and 170.

As illustrated in FIG. 1, the interface management platform 111 may provide the user 140 with creation, publication and management environment for interfaces. In some embodiments, the interface management platform 111 may be a low-code platform that provides a set of tools for interface creation. The interface management platform 111 may support the visual development of interfaces. The interface management platform 111 may support any suitable platform for the users to develop interfaces.

The interface management platform 111 may be deployed on the server 110, or may also be deployed locally on the terminal device 120 of the user 140, and/or may be supported by a remote server. For example, the terminal device 120 of the user 140 may run a client of the interface management platform 111, and the client may support the interaction between the user 140 and the interface management platform 111. In the case where the interface management platform runs locally on the terminal device 120 of the user 140, the user 140 may directly interact with the local interface management platform by using the client. In the case where the interface management platform 111 runs on the server 110, the server 110 may provide service to the client running on the terminal device 120 based on the communication connection with the terminal device 120.

The terminal device 160 may be deployed with a digital assistant 161, and the user 180 may interact with the digital assistant 161 through the terminal device 160 or an attachment device of the terminal device 160. The terminal device 160 and the terminal device 120 may be implemented as the same device or may be implemented as different devices. The digital assistant 161 is provided to assist the user 180 in various task processing requirements in different applications and scenarios. The digital assistant 161 typically has intelligent conversation and task processing capabilities. During the interaction with the digital assistant 161, the user 180 inputs interaction messages (e.g., conversation contents in text, voice, image, video, or other modalities), and the digital assistant 161 responds to the user input by providing reply messages. Generally, the digital assistant 161 is capable of supporting the user 180 in inputting questions in a natural language format. The digital assistant 161 may perform tasks and provide replies based on its understanding of the natural language input and logical reasoning capabilities. The digital assistant 161 may further be configured to call matched interfaces to provide reply messages according to the user input, thereby improving the processing capability of the digital assistant 161.

In some embodiments of the present disclosure, the user 140 may create and publish an interface on the interface management platform 111 as needed. The interface may be published to any appropriate interface application platform 151, provided that the interface application platform 151 is capable of supporting the call to the interface by the digital assistant 161. The interface application platform 151 may be deployed on the server 150, or may also be deployed on the terminal device 160 of the user 180. The server 150 and the server 110 may be implemented as the same device, or may also be implemented as different devices. After the interface is published, the user 180 may input conversation messages in the conversation window of the digital assistant 161. Based on the interface definition for the interface, the digital assistant 161 may request the interface application platform 151 to assist in calling the interface, acquire feedback information from the interface, determine reply messages based on the feedback information, and present the reply messages to the user in the conversation window.

In some embodiments, the interface management platform 111 may support the creation, publication and management of the interfaces with the machine learning model 130. The digital assistant 161 may support interaction with the user 180 with the machine learning model 170. For example, the digital assistant 161 may provide the question-answer service to the user 180 with one or more machine learning models 170. The machine learning model 130 and the machine learning model 170 may be implemented as the same machine learning model, or may be implemented as different machine learning models. The machine learning models 130 and 170 may be different types of models.

In some embodiments, the one or more machine learning models 130 and 170 may be constructed based on a language model (LM). The machine learning model used is a content generating model, which may generate the corresponding output based on the model input. In some embodiments, the machine learning model based on the language model is capable of processing text-modality model input (e.g., natural language and/or machine language) and/or non-text-modality model input (e.g., image, speech, video, etc.), and generating the desired output based on the model input and the prompt. The prompt here is used to guide the machine learning model to generate the output that may address the user's needs indicated by the model input. In the application scenario for supporting the user conversation, the user input may be provided to machine learning model 170 as at least a portion of the model input (other portions may include the prompt). The user input is regarded as the question. Based on the model output, a corresponding reply may be generated and provided to the user 180.

The interface management platform 111 and/or the interface application platform 151 may run in an appropriate electronic device. The electronic device here may be any type of device having computing capabilities, including a terminal device or a server device. The terminal device may be any suitable type of mobile terminal, fixed terminal, or portable terminal, including a mobile phone, a desktop computer, a laptop computer, a notebook computer, a netbook computer, a tablet computer, a media computer, a multimedia tablet, a palmtop computer, a portable game terminal, a VR/AR device, and a Personal Communication System, a PCS) device, a personal navigation device, a personal digital assistant (PDA), an audio/video player, a digital camera/camcorder, a positioning device, a television receiver, a radio broadcast receiver, an electronic book device, a game device, or any combination of the foregoing, including accessories and peripherals for these devices, or any combination thereof. The servers 110, 150 may include, for example, computing systems/servers such as mainframes, edge compute nodes, compute devices in a cloud environment, etc. In some embodiments, the interface management platform 111 and/or the interface application platforms 151 may be implemented based on cloud services.

It should be understood that the structure and function of the various elements in the environment 100 are described for exemplary purposes only, and are not intended to imply any limitation on the scope of the present disclosure.

As mentioned previously, the digital assistant may provide the question-answer service to the user with the machine learning model. For the user input, the machine learning model may directly generate the corresponding response, or determine the interface (such as an API) required to be called. The digital assistant may call the API determined by the machine learning model to generate the response to the user input. The API needs to be understood by the machine learning model, such that in the process of providing the question-answer service to the user with the machine learning model, the machine learning model may determine the API required to be called based on the user input.

In the related art, the developer generally needs to create the API definition for the client of a conventional application, and provide the API definition to the client of the application, such that the client may call the corresponding API based on the API definition. The developer also needs to create a further API definition for the machine learning model, such that the machine learning model may understand the corresponding API according to the further API definition. This will increase the difficulty and cost of the interface development, and there is still room for improvement in making the API definitions developed manually understandable by the machine learning model and enabling accurate call of the corresponding API.

In view of the above, according to embodiments of the present disclosure, a solution for interface processing is provided. According to the solution of the embodiments of the present disclosure, in response to a request to create an interface, the interface definition for the interface is obtained. The first definition content in the interface definition and a prompt are provided to the machine learning model, to obtain the second definition content generated by the machine learning model for the interface. The interface definition for the interface is updated based on the second definition content, and the interface is created with the updated interface definition.

In this way, during the process of creating the interface, by generating or optimizing at least some of the definition content in the interface definition with the machine learning model, the difficulty and cost of the interface development for the developer may be reduced. Moreover, the interface definition may easily be understood by the machine learning model, and it is beneficial to improve the accuracy and the success rate of interface calling.

Some example embodiments of the present disclosure will be described below with continued reference to the accompanying drawings.

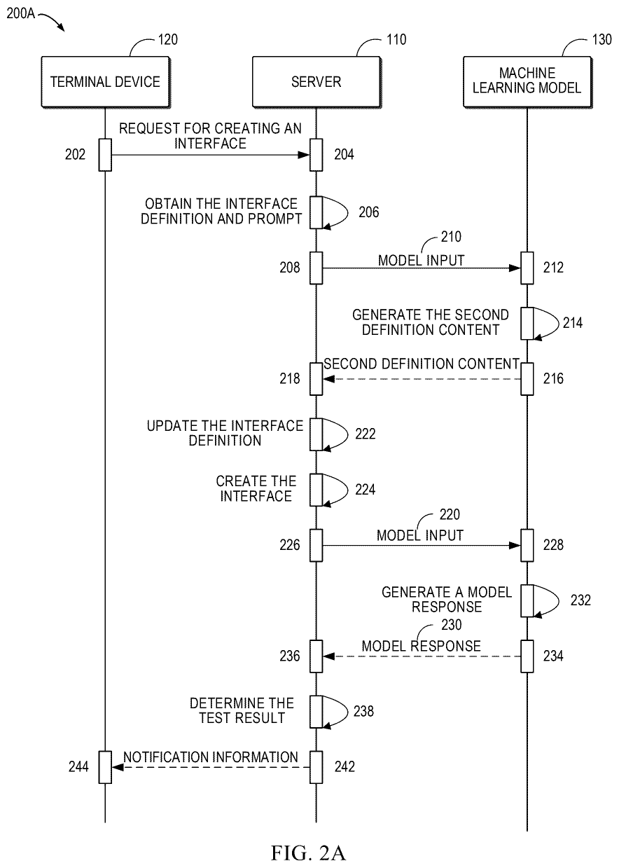

FIG. 2A illustrates a flow diagram of a signaling flow 200A for interface processing according to some embodiments of the present disclosure. The signaling flow 200A involves a server 110, a terminal device 120, and a machine learning model 130. For ease of discussion, the signaling flow 200A will be described with reference to the environment of FIG. 1.

In some embodiments of the present disclosure, as illustrated in the signaling flow 200A, the terminal device 120 transmits (202) a request for creating an interface to the server 110. The server 110 receives (204) the request for creating the interface from the terminal device 120. The server 110 obtains (206) an interface definition for the interface.

The interface definition here may be included in the request for creating the interface, or the server 110 may, in response to receiving the request for creating the interface, interact with the terminal device 120 to receive the interface definition for the interface from the terminal device 120. In some embodiments, the interface definition may be input by the user corresponding to the terminal device 120.

The interface definition here may include all or part of fields required for creating the interface. For example, all or part of fields may include a classification field, an identification field, a description field, an address field, an input field, an output field, and the like of the interface. The following provides an example of the interface definition.

Alternatively, or additionally, all or part of the fields here may include the field names of all or part of the fields and field information of at least some of the all or part of the fields. For example, the interface definition may include respective field names of fields in all or part of the fields, and each field name in the interface definition may have corresponding field information. Alternatively, only part of the field names in the interface definition may have corresponding field information, and the remaining fields may not have the corresponding field information. For example, the interface definition may merely include the field name that describes the description field of the interface (such as api_desc), and not include the field information corresponding to the description field.

It may be understood that the foregoing fields are merely exemplary, and the interface definition may include all or part of the foregoing fields. The interface definition may further include other fields, such as the “method” field for defining the HTTP method used when submitting the form or making a network request for the interface, the “package” field for defining the classification to which the interface belongs, the “api_name” field for defining the interface name when the interface is provided to the machine learning model, the “api_show_name” field for defining the interface name when the interface is presented to the user, the “request_params” field for defining the input parameter of the interface, and the “response_params” field for defining the output parameter of the interface, and the “double_check” field for defining whether the secondary confirmation is required when the interface is called by the machine learning model, etc., which are not listed one by one here.

In practical applications, the number of fields included in the interface definition may be determined according to specific needs, and the name and requirement of each field may also be adjusted as needed. Embodiments of the present disclosure are not limited thereto.

In some embodiments, the classification architecture of the interface may include one or more tree structures. The tree structure may include a root node, a child node, and a leaf node, and each interface may be recorded at the leaf node. The classification field of the interface may be configured to record the classification path of the interface in the tree structure. It may be understood that, in specific implementation, the classification type corresponding to the root node, the child node and the leaf node may be flexibly selected according to a plurality of classification manners, and the specific classification types corresponding to the root node, the child node and the leaf node are not limited herein.

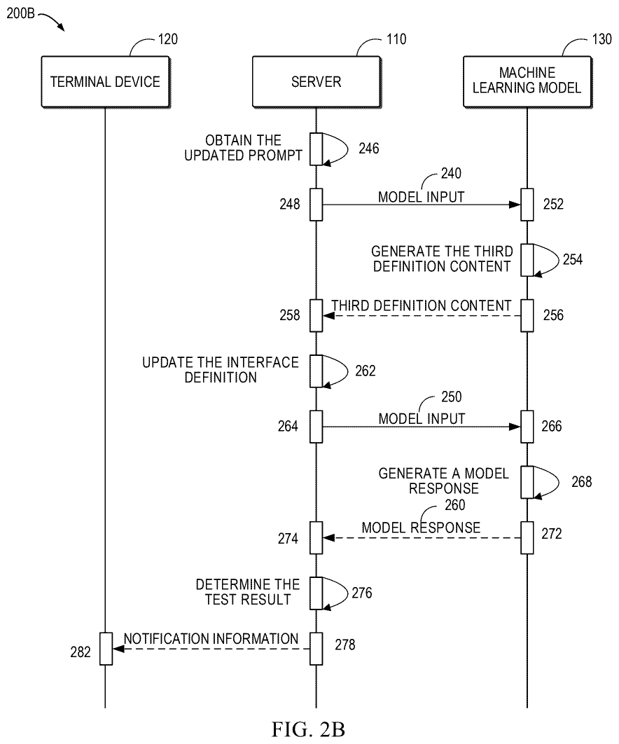

In an example, as illustrated in FIG. 3, FIG. 3 illustrates a diagram of an example 300 of a classification architecture for interfaces according to some embodiments of the present disclosure. In the example 300, there are tree structures 300A, 300B, 300C. The tree structure 300A includes a root node 311, a plurality of primary child nodes, a plurality of secondary child nodes, and a plurality of leaf nodes. In the tree structure 300A to which the interface 341 belongs, the classification path of the interface 341 in the tree structure 300A may include the root node 311, the primary child node 321 and the secondary child node 331. On this basis, the field information of the “package” field may include, for example, the root node 311/primary child node 321/secondary child node 331.

In some embodiments of the present disclosure, as illustrated in the signaling flow 200A, the server 110 constructs the model input 210 of the machine learning model 130 based on the first definition content in the interface definition and the prompt, and provides (208) the model input 210 to the machine learning model 130. The machine learning model receives (212) the model input 210, and generates (214) a second definition content for the interface (which may also be referred to as a model response).

The first definition content here may include one or more fields in the interface definition. In some embodiments, the first definition content includes respective field names of one or more fields and field information of at least some of the one or more fields. Alternatively, or additionally, the one or more fields may include fields that facilitate the machine learning model understanding the interface. The one or more fields may further include fields that require the machine learning model to generate the field information, and fields that require the machine learning model to optimize the field information. With respect to fields that facilitate the machine learning model understanding the interface, both the field name and the field information of the fields may be provided to the machine learning model. With respect to fields that require the machine learning model to optimize the field information, both the field name and the field information need to be optimized before the fields may be provided to the machine learning model. With respect to fields that require the machine learning model to generate the field information, the field names of the fields may be provided to the machine learning model.

The prompt here may be used to guide the machine learning model to generate the second definition content for the interface based on the first definition content. In some embodiments, the prompt includes at least the generation requirement for the definition content of the interface. For example, the prompt may include the generation requirement for the second definition content of the interface. Alternatively, or additionally, the prompt may include the generation criterion for the field name of the second definition content and the field information corresponding to the field name.

The second definition content here may include the field information generated by the machine learning model for at least some of the one or more fields. Alternatively, or additionally, the second definition content may further include the field name corresponding to the generated field information, such that the server 110 may correctly determine the correspondence between the field information and the field name. For example, the second definition content may include the optimized field information and the corresponding field name, and the generated field information and the corresponding field name.

In some embodiments, the second definition content may be provided to the machine learning model or a further machine learning model, to determine the call to the interface. On this basis, the second definition content may include fields required by the machine learning model or the further machine learning model to determine the interface to be called. For example, the second definition content may include fields provided to machine learning model 130 or machine learning model 170 to determine the call to the interface.

In some embodiments, the second definition content includes at least one of: an identifier corresponding to the identification field of the interface, description information corresponding to the description field of the interface, input parameters corresponding to one or more input fields of the interface, or output parameters corresponding to one or more output fields of the interface.

For example, the first definition content may include the field names of the following fields: “package”, “api_name”, “api_show_name”, “api_desc”, “api_show_desc”, “url”, “method”, “double_check” “request_params”, “response_params”, and “function_id”. The first definition content further includes field information of the following fields: “package”, “api_show_name”, “api_show_desc”, “url”, “method”, “double_check”, and “function_id”.

On this basis, the second definition content may include the field information and field names of the following fields: “api_name”, “api_show_desc”, “request_params”, and “response_params”. The field information of the “request_params” field may include the input parameters corresponding to the following input fields such as “name”, “description”, “required”, “type”, “SubParameters”, “enum”, etc.

In embodiments of the present disclosure, as illustrated in the signaling flow 200A, the machine learning model 130 feeds back, or returns, (216) the second definition content to the server 110. The server 110 receives (218) the second definition content, and updates (222) the interface definition for the interface based on the second definition content. The server 110 creates (224) the interface with the updated interface definition.

The second definition content here may include the field information generated by the machine learning model 130 for at least some of the one or more fields in the first definition content. When a field in the second definition content has field information in the non-undated interface definition, the server 110 may use the field information of the field generated by the machine learning model 130 to replace the existing field information of the field in the non-undated interface definition. When a field in the second definition content has no field information in the non-undated interface definition, the server 110 may fill the field information of the field generated by the machine learning model 130 into the interface definition, to update the interface definition for the interface.

In some embodiments of the present disclosure, as illustrated in the signaling flow 200A, the server 110 constructs a model input 220 of the machine learning model 130 based on the test question for the interface and the updated interface definition for the interface, and provides (226) the model input 220 to the machine learning model 130. The machine learning model 130 receives (228) the model input 220 and generates (232) a model response 230. The machine learning model 130 returns (234) the model response 230 to the server 110. The server 110 receives (236) the model response 230, and determines (238) the test result for the interface based on the model response 230.

Alternatively, or additionally, the server 110 may construct the model input 220 of the machine learning model 130 based on the test question and all or part of fields in the updated interface definition. For example, the server 110 may construct the model input 220 of the machine learning model based on the test question and at least the fields in the second definition content.

In some embodiments, the server 110 may receive the model response 230 to the test question from the machine learning model 130. In response to the model response 230 failing to indicate a call to the interface, it is determined that the test result indicates a failed test on the interface. For example, if the model response 230 does not include the call parameter for the interface, it may be determined that the test on the interface fails. This situation may be due to inaccurate description information in the interface definition, causing the machine learning model 130 to not correctly understand the function of the tested interface, and making the machine learning model 130 unable to determine that the tested interface should be called to respond to the test question.

When the model response 230 at least indicates the call parameter for the interface, the server 110 may transmit a call request to the interface based on the call parameter and the call address indicated in the interface definition. When the server 110 receives target feedback information for the test question from the interface, it is determined that the test on the interface succeeds. For example, when the machine learning model 130 determines that it is needed to call the tested interface to respond to the test question, and by transmitting the call request to the interface based on the call parameter provided by the machine learning model 130, it is able to receive correct target feedback information for the test question from the interface, it may be determined that the test on the interface succeeds. As illustrated in the signaling flow 200A, when the server 110 determines that the test on the interface succeeds, the server 110 may provide (242) notification information to the terminal device 120. The terminal device 120 receives (244) the notification information, and determines that the interface creation is complete.

In response to failing to receive the target feedback information for the test question from the interface, it is determined that the test on the interface fails. An example case where the server 110 fails to receive the target feedback information for the test question from the interface is that the interface determined by machine learning model 130 based on the test question is not the tested interface. This situation may be due to inaccurate description information in the interface definition, causing the machine learning model 130 to incorrectly understand the function of the tested interface, and making the machine learning model 130 unable to determine that the tested interface should be called to respond to the test question.

Another example case where the server 110 fails to receive the target feedback information for the test question from the interface is that, the machine learning model 130 determines that it is needed to call the tested interface based on the test question, but it fails to obtain the correct target feedback information after the call request is transmitted to the interface based on the call parameter. This situation may be due to an incorrect call parameter fed back by the machine learning model 130 based on the interface definition, resulting in the server 110 failing to correctly call the tested interface, or failing to obtain the correct target feedback information from the tested interface.

Alternatively, or additionally, the incorrect call parameters here may include one or more input parameters of the interface being incorrect, and/or one or more output parameters of the interface being incorrect. In the case where one or more input parameters are incorrect, the server 110 may not call the tested interface correctly. In the case where one or more output parameters are incorrect, the interface may not feed back correct target feedback information.

The process after it is determined that the test result indicates the failed test on the interface will be described below with reference to FIG. 2B. FIG. 2B illustrates a flowchart of a signaling flow 200B for interface processing according to some embodiments of the present disclosure. The signaling flow 200B involves the server 110, the terminal device 120 and the machine learning model 130. It will be appreciated that the signaling flow 200B may be performed subsequent to the signaling flow 200A. For ease of discussion, the signaling flow 200B will be described with reference to the environment of FIG. 1.

In some embodiments of the present disclosure, as illustrated in the signaling flow 200B, when it is determined that the test result indicates the failed test on the interface, the server 130 may obtain (246) the updated prompt. The server 130 may construct the model input 240 of the machine learning model 130 based on the first definition content and the updated prompt, and provide (248) the model input 240 to the machine learning model 130. The machine learning model 130 obtains (252) the model input 240, and generates (254) a third definition content.

As may be seen from the foregoing analysis, the failed test on the interface may be due to inaccurate description information of the interface or incorrect call parameter fed back by the machine learning model 130. These issues may be due to inaccurate generation requirements for the second definition content in the prompt. The prompt configured to instruct the machine learning model 130 to generate the second definition content may be updated. On this basis, the prompt may be updated, and the machine learning model 130 may be triggered to generate the third definition content based on the updated prompt. The third definition content here may include all or part of the fields in the second definition content. For example, the updated prompt may instruct the machine learning model 130 to regenerate all of the fields in the second definition content. For example, when it is detected that the description information is inaccurate, the input parameter is incorrect, or the output parameter is incorrect, the machine learning model 130 may be instructed to regenerate the interface's description information, one or more input parameters, one or more output parameters, etc. with the updated prompt.

In some embodiments of the present disclosure, as illustrated in the signaling flow 200B, the machine learning model 130 feeds back (256) the third definition content to the server 110. The server 110 receives (258) the third definition content, and updates (262) the interface definition for the interface based on the third definition content.

In some embodiments of the present disclosure, as illustrated in the signaling flow 200B, the server 110 constructs the model input 250 of the machine learning model 130 based on test question for the interface and the updated interface definition for the interface, and provides (264) the model input 250 to the machine learning model 130. The machine learning model 130 receives (266) the model input 250, and generates (268) the model response 260. The machine learning model 130 returns (272) the model response 260 to the server 110. The server 110 receives (274) the model response 260, and determines (276) the test result for the interface based on the model response 260.

It will be appreciated that in an actual interface creation process, if the interface is successfully tested at once, the process illustrated in the signaling flow 200B may not occur. If there is one or more test failures on the interface, the process illustrated in the signaling flow 200B may be performed once or repeatedly performed multiple times.

In some embodiments of the present disclosure, as illustrated in the signaling flow 200B, when it is determined that the test result indicates a successful test on the interface, the server 110 may provide (278) notification information to the terminal device 120. The terminal device 120 may receive (282) the notification information, and determine that the interface creation is complete.

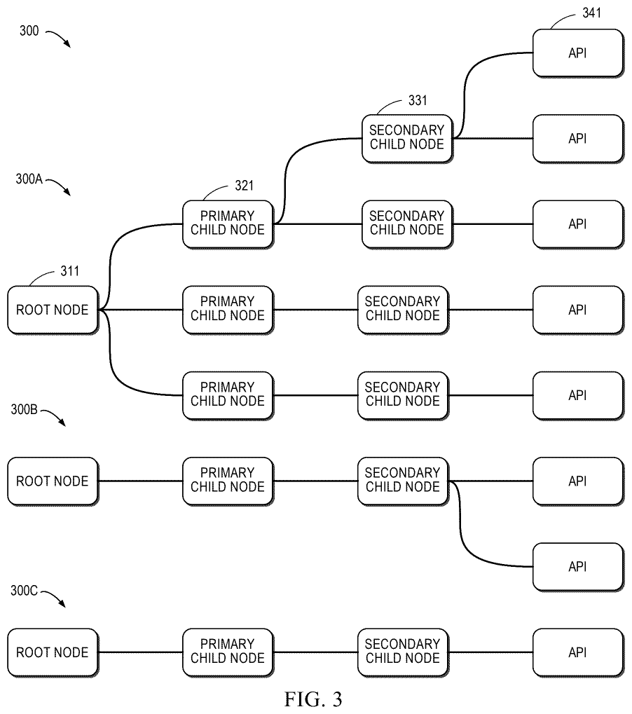

The process after interface creation is complete will be described below with reference to FIG. 4. FIG. 4 illustrates a flow diagram of a signaling flow 400 for interface processing according to some embodiments of the present disclosure. The signaling flow 400 involves a server 150, a terminal device 160, and a machine learning model 170. For ease of discussion, the signaling flow 400 will be described with reference to the environment of FIG. 1.

In some embodiments of the present disclosure, as illustrated in the signaling flow 400, the terminal device 160 may, in response to a triggering operation of the user 180 on the digital assistant 161, transmit (402) the call parameter 410 to the server 150. The server 150 may receive (404) the call parameter 410 from the terminal device 160, transmit (406) a request to call the corresponding interface based on the call parameter 410, and receive feedback information 420 from the corresponding interface.

In some embodiments of the present disclosure, as illustrated in the signaling flow 400, the server 150 may transmit (408) the feedback information 420 to the terminal device 160. The terminal device 160 may receive (412) the feedback information 420 from the server 150.

The above describes the process in which the user 180 may operate the digital assistant 161 through the terminal device 160 or the attachment device of the terminal device 160, and trigger the digital assistant to directly transmit the call parameter to the server 150, thereby calling the interface. In the above process, the server 150 does not need to request the machine learning model 170 to determine the interface to be called, and does not need to request the machine learning model 170 to determine the call parameter of the interface.

The following will continue to describe the example interaction process of the terminal device 160, the server 150, and the machine learning model 170 in the scenario where the user 180 has a conversation with the digital assistant 161 with reference to the signaling flow 400.

In some embodiments of the present disclosure, as illustrated in the signaling flow 400, the terminal device 160 may transmit (414), in response to receiving a question from the user 180, the question to the server 150. The server 150 receives (416) the question, and transmits (418) the question to the machine learning model 170. The machine learning model 170 may receive (422) the question, and generate (424) a model response 430. The model response 430 here may include the call parameter for the interface.

In some embodiments of the present disclosure, as illustrated in the signaling flow 400, the machine learning model 170 may transmit (426) the model response 430 to the server 150. The server 150 may receive (428) the model response 430, call (432) the corresponding interface based on the call parameter in the model response 430, and obtain feedback information 440 provided by the interface. The server 150 may then transmit (434) the feedback information 440 to the terminal device 160. The terminal device 160 may receive (436) the feedback information 440, and present the feedback information 440 with the digital assistant.

According to embodiments of the present disclosure, during the process of creating the interface, the difficulty and cost of the interface development for the developer may be reduced. Moreover, the interface definition may be easily understood by the machine learning model, and it is beneficial to improve the accuracy and the success rate of interface calling.

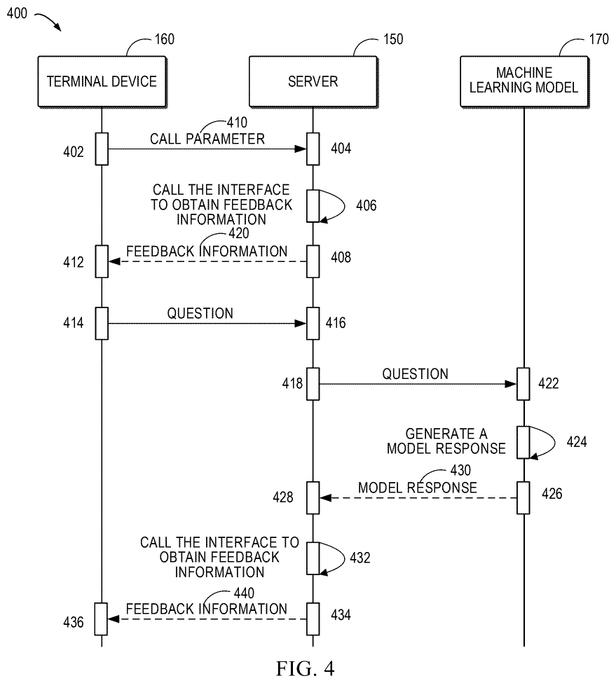

FIG. 5 illustrates a flowchart of a process 500 for interface processing according to some embodiments of the present disclosure. The process 500 may be implemented at the server 110.

At block 510, the server 110 obtains an interface definition for the interface in response to a request to create an interface.

At block 520, the server 110 provides first definition content in the interface definition and a prompt to a machine learning model, to obtain a second definition content generated by the machine learning model for the interface.

At block 530, the server 110 updates the interface definition for the interface based on the second definition content.

At block 540, the server 110 creates the interface with the updated interface definition.

In some embodiments, the prompt includes at least the generation requirement for a definition content of the interface.

In some embodiments, the first definition content includes one or more fields in the interface definition.

In some embodiments, the first definition content includes respective field names of the one or more fields and field information of at least some of the one or more fields.

In some embodiments, the second definition content includes field information generated by the machine learning model for at least some of the one or more fields.

In some embodiments, the second definition content includes at least one of: an identifier corresponding to an identification field of the interface, description information corresponding to a description field of the interface, input parameters corresponding to one or more input fields of the interface, or output parameters corresponding to one or more output fields of the interface.

In some embodiments, at least the second definition content is provided to the machine learning model or a further machine learning model for determining the call to the interface.

In some embodiments, the process 500 further includes: determining a test result for the interface by providing a test question for the interface and the updated interface definition for the interface to the machine learning model.

In some embodiments, the process 500 further includes: receiving a model response to the test question from the machine learning model; in response to the model response failing to indicate a call to the interface, determining that the test result indicates a failed test on the interface; and in response to the model response at least indicating a call parameter for the interface, transmitting a call request to the interface based on the call parameter and a call address indicated in the interface definition, in response to receiving target feedback information for the test question from the interface, determining a succeeded test on the interface, and in response to failing to receive the target feedback information for the test question from the interface, determining a failed test on the interface.

In some embodiments, the process 500 further includes: in response to the test result indicating a failed test on the interface, obtaining an updated prompt; providing the first definition content and the updated prompt to the machine learning model, to obtain a third definition content regenerated by the machine learning model; and updating the interface definition for the interface based on the third definition content.

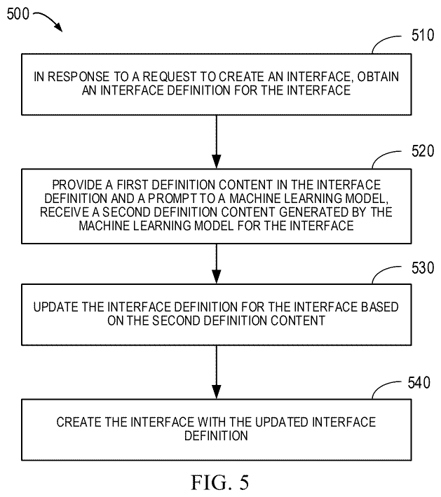

Embodiments of the present disclosure also provide corresponding apparatus for implementing the methods or processes described above. FIG. 6 illustrates an example block diagram of an apparatus 600 for interface processing according to some embodiments of the present disclosure. The apparatus 600 may be implemented as the server 110 or included in the server 110. The various modules/components in the apparatus 600 may be implemented by hardware, software, firmware, or any combination thereof.

As illustrated in FIG. 6, the apparatus 600 includes an obtaining module 610, a providing module 620, an updating module 630, and a creating module 640. The obtaining module 610 is configured to, in response to a request to create an interface, obtain an interface definition for the interface. The providing module 620 is configured to provide a first definition content in the interface definition and a prompt to a machine learning model, to obtain a second definition content generated by the machine learning model for the interface. The updating module 630 is configured to update the interface definition for the interface based on the second definition content. The creating module 640 is configured to create the interface with the updated interface definition.

In some embodiments, the prompt includes at least the generation requirement for a definition content of the interface.

In some embodiments, the first definition content includes one or more fields in the interface definition.

In some embodiments, the first definition content includes respective field names of the one or more fields and field information of at least some of the one or more fields.

In some embodiments, the second definition content includes field information generated by the machine learning model for at least some of the one or more fields.

In some embodiments, the second definition content includes at least one of: an identifier corresponding to an identification field of the interface, description information corresponding to a description field of the interface, input parameters corresponding to one or more input fields of the interface, or output parameters corresponding to one or more output fields of the interface.

In some embodiments, at least the second definition content is provided to the machine learning model or a further machine learning model for determining the call to the interface.

In some embodiments, the apparatus 600 further includes a testing module. The testing module is configured to determine a test result for the interface by providing a test question for the interface and the updated interface definition for the interface to the machine learning model.

In some embodiments, the testing module is further configured to: receive a model response to the test question from the machine learning model; in response to the model response failing to indicate a call to the interface, determine that the test result indicates a failed test on the interface; and in response to the model response at least indicating a call parameter for the interface, transmit a call request to the interface based on the call parameter and a call address indicated in the interface definition, in response to receiving target feedback information for the test question from the interface, determine a succeeded test on the interface, and in response to failing to receive the target feedback information for the test question from the interface, determine a failed test on the interface.

In some embodiments, the testing module is further configured to: in response to the test result indicating a failed test on the interface, obtain an updated prompt; provide the first definition content and the updated prompt to the machine learning model, to obtain a third definition content regenerated by the machine learning model; and update the interface definition for the interface based on the third definition content.

The units and/or modules included in the apparatus 600 may be implemented in a variety of ways, including software, hardware, firmware, or any combination thereof. In some embodiments, one or more units and/or modules may be implemented using software and/or firmware, such as machine-executable instructions stored on a storage medium. In addition to or as an alternative to machine executable instructions, some or all of the units and/or modules in apparatus 600 may be implemented, at least in part, by one or more hardware logic components. By way of example, and not limitation, illustrative types of hardware logic components that can be used include Field-programmable Gate Arrays (FPGAs), Program-specific Integrated Circuits (ASICs), Program-specific Standard Products (ASSPs), System-on-a-chip systems (SOCs), Complex Programmable Logic Devices (CPLDs), etc.

It should be understood that one or more steps of the above methods may be performed by a suitable electronic device or combination of electronic devices. Such electronic devices or combinations of electronic devices may include, for example, the server 110 in FIG. 1.

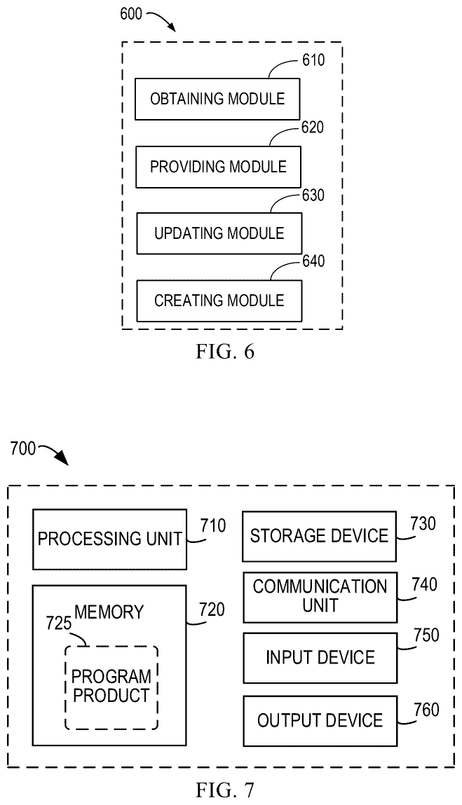

FIG. 7 illustrates a block diagram of an electronic device 700 in which one or more embodiments of the present disclosure may be implemented. It should be appreciated that the electronic device 700 illustrated in FIG. 7 is merely exemplary and should not constitute any limitation on the functionality and scope of the embodiments described herein. The electronic device 700 illustrated in FIG. 7 may be configured to implement the server 110 in FIG. 1, and the electronic device 700 may also be configured to implement the apparatus 600 in FIG. 6.

As illustrated in FIG. 7, the electronic device 700 is in the form of a general-purpose electronic device. Components of the electronic device 700 may include, but are not limited to, one or more processors or processing units 710, a memory 720, a storage device 730, one or more communication units 740, one or more input devices 750, and one or more output devices 760. The processing unit 710 may be an actual or virtual processor and can perform various processes according to programs stored in the memory 720. In a multiprocessor system, a plurality of processing units execute computer executable instructions in parallel to improve the parallel processing capability of the electronic device 700.

Electronic device 700 typically includes a number of computer storage media. Such media may be any available media that is accessible to electronic device 700, including, but not limited to, volatile and non-volatile media, removable and non-removable media. Memory 720 may be volatile memory (e.g., registers, cache, random access memory (RAM)), non-volatile memory (e.g., read-only memory (ROM), electrically erasable programmable read-only memory (EEPROM), flash memory), or some combination thereof. Storage device 730 may be a removable or non-removable medium and may include a machine-readable medium such as a flash drive, a magnetic disk, or any other medium that may be used to store information and/or data and that may be accessed within electronic device 700.

The electronic device 700 may further include additional removable/non-removable, volatile/nonvolatile storage media. Although not illustrated in FIG. 7, a magnetic disk drive for reading from or writing to a removable, nonvolatile magnetic disk such as a “floppy disk” and an optical disk drive for reading from or writing to a removable, nonvolatile optical disk may be provided. In these cases, each drive may be connected to a bus (not illustrated) by one or more data media interfaces. Memory 720 may include a computer program product 725 having one or more program modules configured to perform various methods or actions of various embodiments of the present disclosure.

The communication unit 740 enables communication with other electronic devices over a communication medium. Additionally, the functionality of the components of the electronic device 700 may be implemented in a single computing cluster or in multiple computing machines that are capable of communicating over a communication connection. Thus, the electronic device 700 may operate in a networked environment using logical connections to one or more other servers, network personal computers (PCs), or another network node.

Input device(s) 750 may be one or more input devices such as a mouse, keyboard, trackball, etc. Output device(s) 760 may be one or more output devices such as a display, speakers, printer, etc. The electronic device 700 may also communicate with one or more external devices (not illustrated), such as storage devices, display devices, etc., as needed through the communication unit 740, with one or more devices that enable a user to interact with the electronic device 700, or with any device (e.g., network card, modem, etc.) that enables the electronic device 700 to communicate with one or more other electronic devices. Such communication may be performed via an input/output (I/O) interface (not illustrated).

According to an exemplary implementation of the present disclosure, a computer-readable storage medium is provided, on which a computer-executable instruction is stored, wherein the computer-executable instruction is executed by a processor to implement the above-described method. According to an exemplary implementation of the present disclosure, there is also provided a computer program product, which is tangibly stored on a non-transitory computer-readable medium and includes computer-executable instructions that are executed by a processor to implement the method described above.

Aspects of the present disclosure are described herein with reference to flowchart illustrations and/or block diagrams of methods, apparatus, devices and computer program products implemented in accordance with the present disclosure. It will be understood that each block of the flowchart illustrations and/or block diagrams, and combinations of blocks in the flowchart illustrations and/or block diagrams, can be implemented by computer-readable program instructions.

These computer-readable program instructions may be provided to a processing unit of a general-purpose computer, special purpose computer, or other programmable data processing apparatus to produce a machine, such that the instructions, which execute via the processing unit of the computer or other programmable data processing apparatus, create means for implementing the functions/acts specified in the flowchart and/or block diagram block or blocks. These computer-readable program instructions may also be stored in a computer-readable storage medium that can direct a computer, programmable data processing apparatus, and/or other devices to function in a particular manner, such that the computer-readable medium storing the instructions includes an article of manufacture including instructions which implement various aspects of the functions/acts specified in the flowchart and/or block diagram block or blocks.

The computer readable program instructions may be loaded onto a computer, other programmable data processing apparatus, or other devices, causing a series of operational steps to be performed on a computer, other programmable data processing apparatus, or other devices, to produce a computer implemented process such that the instructions which execute on the computer, other programmable data processing apparatus, or other devices implement the functions/acts specified in the flowchart and/or block diagram block or blocks.

The flowchart and block diagrams in the Figures illustrate the architecture, functionality, and operation of possible implementations of systems, methods and computer program products according to various implementations of the present disclosure. In this regard, each block in the flowchart or block diagrams may represent a module, segment, or portion of an instruction which includes one or more executable instructions for implementing the specified logical function(s). In some implementations as an update, the functions noted in the blocks may also occur out of the order noted in the figures. For example, two blocks illustrated in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

Having described implementations of the present disclosure above, the foregoing description is exemplary, not exhaustive, and is not limited to the implementations disclosed. Many modifications and variations will be apparent to those of ordinary skill in the art without departing from the scope and spirit of the implementations described. The choice of terms used herein is intended to best explain the principles of the implementations, the practical application, or improvements to technologies in the marketplace, or to enable others of ordinary skill in the art to understand the implementations disclosed herein.

1. A method for interface processing, comprising:
in response to a request to create an interface, obtaining an interface definition for the interface;
providing a first definition content in the interface definition and a prompt to a machine learning model;
receiving a second definition content generated by the machine learning model for the interface;
updating the interface definition for the interface based on the second definition content; and
creating the interface with the updated interface definition.

2. The method of claim 1, wherein the prompt comprises at least a generation requirement for a definition content of the interface.

3. The method of claim 1, wherein the first definition content comprises one or more fields in the interface definition.

4. The method of claim 3, wherein the first definition content comprises respective field names of the one or more fields and field information of at least some of the one or more fields.

5. The method of claim 3, wherein the second definition content comprises field information generated by the machine learning model for at least some of the one or more fields.

6. The method of claim 1, wherein the second definition content comprises at least one of:
an identifier corresponding to an identification field of the interface,
description information corresponding to a description field of the interface,
input parameters corresponding to one or more input fields of the interface, or
output parameters corresponding to one or more output fields of the interface.

7. The method of claim 1, wherein at least the second definition content is provided to the machine learning model or a further machine learning model for determining a call to the interface.

8. The method of claim 1, further comprising:
determining a test result for the interface by providing a test question for the interface and the updated interface definition for the interface to the machine learning model.

9. The method of claim 8, wherein determining the test result for the interface comprises:
receiving a model response to the test question from the machine learning model;
in response to the model response failing to indicate a call to the interface, determining that the test result indicates a failed test on the interface; and
in response to the model response at least indicating a call parameter for the interface,
transmitting a call request to the interface based on the call parameter and a call address indicated in the interface definition,
in response to receiving target feedback information for the test question from the interface, determining a succeeded test on the interface, and
in response to failing to receive the target feedback information for the test question from the interface, determining a failed test on the interface.

10. The method of claim 8, further comprising:
in response to the test result indicating a failed test on the interface, obtaining an updated prompt;
providing the first definition content and the updated prompt to the machine learning model, to obtain a third definition content regenerated by the machine learning model; and
updating the interface definition for the interface based on the third definition content.

11. An electronic device, comprising:
at least one processing unit;
at least one memory coupled to the at least one processing unit and storing instructions for execution by the at least one processing unit that, when executed by the at least one processing unit, cause the electronic device to perform operations comprising:
in response to a request to create an interface, obtaining an interface definition for the interface;
providing a first definition content in the interface definition and a prompt to a machine learning model;
receiving a second definition content generated by the machine learning model for the interface;
updating the interface definition for the interface based on the second definition content; and
creating the interface with the updated interface definition.

12. The electronic device of claim 11, wherein the first definition content comprises one or more fields in the interface definition.

13. The electronic device of claim 12, wherein the first definition content comprises respective field names of the one or more fields and field information of at least some of the one or more fields.

14. The electronic device of claim 12, wherein the second definition content comprises field information generated by the machine learning model for at least some of the one or more fields.

15. The electronic device of claim 11, wherein the second definition content comprises at least one of:
an identifier corresponding to an identification field of the interface,
description information corresponding to a description field of the interface,
input parameters corresponding to one or more input fields of the interface, or
output parameters corresponding to one or more output fields of the interface.

16. The electronic device of claim 11, wherein at least the second definition content is provided to the machine learning model or a further machine learning model for determining a call to the interface.

17. The electronic device of claim 11, wherein the operations further comprise:
determining a test result for the interface by providing a test question for the interface and the updated interface definition for the interface to the machine learning model.

18. The electronic device of claim 17, wherein determining the test result for the interface comprises:
receiving a model response to the test question from the machine learning model;
in response to the model response failing to indicate a call to the interface, determining that the test result indicates a failed test on the interface; and
in response to the model response at least indicating a call parameter for the interface,
transmitting a call request to the interface based on the call parameter and a call address indicated in the interface definition,
in response to receiving target feedback information for the test question from the interface, determining a succeeded test on the interface, and
in response to failing to receive the target feedback information for the test question from the interface, determining a failed test on the interface.

19. The electronic device of claim 17, wherein the operations further comprise:
in response to the test result indicating a failed test on the interface, obtaining an updated prompt;
providing the first definition content and the updated prompt to the machine learning model, to obtain a third definition content regenerated by the machine learning model; and
updating the interface definition for the interface based on the third definition content.

20. A non-transitory computer readable storage medium having a computer program stored thereon, wherein the computer program is executable by a processor to perform operations comprising:
in response to a request to create an interface, obtaining an interface definition for the interface;
providing a first definition content in the interface definition and a prompt to a machine learning model;
receiving a second definition content generated by the machine learning model for the interface;
updating the interface definition for the interface based on the second definition content; and
creating the interface with the updated interface definition.
